(19) United States
(12) Patent Application Publication
(10) Pub. No.: US 2026/0268814 A1
(43) Pub. Date: Sep. 10, 2026

(54) DISPLAY CONTROL DEVICE, DISPLAY CONTROL SYSTEM, DISPLAY CONTROL METHOD, AND COMPUTER-READABLE STORAGE MEDIUM

(71) Applicant: NEC Solution Innovators, Ltd., Tokyo (JP)

(72) Inventors: Genki NAKAMURA, Tokyo (JP); Hidehiro TASHiRO, Tokyo (JP); Eiki WATANABE, Tokyo (JP); Tomoko TSUJI, Tokyo (JP)

(73) Assignee: NEC Solution Innovators, Ltd., Tokyo (JP)

(21) Appl. No.: 19/166,999

(22) PCT Filed: Mar. 26, 2024
(86) PCT No.: PCT/JP2024/011811

§ 371 Date: Sep. 19, 2025

(30) Foreign Application Priority Data
Mar. 31, 2023 (JP) 2023-057037

(51) Int. Cl. G09G 3/00

(52) U.S. Cl. CPC G09G 3/001; G09G 2340/0464; G09G 2354/00

(57) ABSTRACT

A display control device that includes a window group formation unit that groups a plurality of relevant virtual windows as a window group, and a placement control unit that determines a window group to be disposed in a region of interest based on a priority of each of the virtual windows.

### TECHNICAL FIELD

The present disclosure relates to a display control device or the like that controls display of a plurality of virtual windows displayed in a virtual space.

### BACKGROUND ART

There is a technique of displaying a plurality of virtual windows in a virtual space using smart glasses. There is no limitation on a size of the virtual space in which the virtual windows can be disposed. Thus, when the plurality of virtual windows is simultaneously opened, it takes time to search for a necessary virtual window, thereby reducing work efficiency. For this reason, when a plurality of virtual windows is simultaneously opened, the virtual windows are desired to be disposed to prevent the work efficiency from being reduced.

PTL 1 discloses a technique for controlling placement of a plurality of windows in an information processing device having a multi-window function for displaying a plurality of windows on one display device.

PTL 1 discloses a multi-window display device that displays the plurality of windows on a display screen. The multi-window display device disclosed in PTL 1 disposes windows corresponding to a plurality of types of application software in respective predetermined display areas set in advance to prevent the windows from overlapping each other.

### CITATION LIST

### Patent Literature

PTL 1: JP 2011-248489 A

### SUMMARY OF INVENTION

### Technical Problem

The technique disclosed in PTL 1 does not consider work efficiency in work using the plurality of windows.

It is an object of the present disclosure to provide a display control device and the like capable of improving work efficiency at work in an environment in which a plurality of virtual windows is simultaneously opened in a virtual space.

### Solution to Problem

A display control device according to an aspect of the present disclosure includes a window group formation unit that groups a plurality of relevant virtual windows as a window group, and a placement control unit that determines a window group to be disposed in a region of interest based on a priority of each of the virtual windows.

A display control method according to another aspect of the present disclosure includes grouping a plurality of relevant virtual windows as a window group using a display control device, and determining a window group to be disposed in a region of interest based on a priority of each of the virtual windows using the display control device.

A storage medium according to yet another aspect of the present disclosure stores a computer program for causing a computer to execute processing of: grouping a plurality of relevant virtual windows into a window group; and determining the window group to be disposed in a region of interest based on a priority of each of the virtual windows.

### Advantageous Effects of Invention

The present disclosure enables improving work efficiency at work in an environment in which a plurality of virtual windows is simultaneously opened in a virtual space.

### BRIEF DESCRIPTION OF DRAWINGS

FIG. 1 is a conceptual diagram for illustrating a field of view of a user who uses a display control system according to a first example embodiment.

FIG. 2 is a block diagram illustrating an example of a configuration of a display control system according to the first example embodiment.

FIG. 3 is a diagram illustrating an example of gaze time information used by the display control system according to the first example embodiment.

FIG. 4 is an image diagram of visual line trajectory information used by the display control system according to the first example embodiment.

FIG. 5 is an example of schedule information used by the display control system according to the first example embodiment.

FIG. 6 is a diagram illustrating an example of placement region definition information referred to by the display control system according to the first example embodiment.

FIG. 7 is a diagram for illustrating a method for calculating a relevance ratio using the display control system according to the first example embodiment.

FIG. 8 is a flowchart illustrating an example of operation of the display control system according to the first example embodiment.

FIG. 9 is a flowchart illustrating an example of operation in placement information generation processing performed by a display control device of the display control system according to the first example embodiment.

FIG. 10 is a block diagram illustrating a configuration of a display control system according to a second example embodiment.

FIG. 11 is a block diagram illustrating a configuration of a display control device according to a second example embodiment.

FIG. 12 is a flowchart illustrating an example of operation of the display control device according to the second example embodiment.

FIG. 13 is a block diagram illustrating an example of a hardware configuration that implements the display control device according to the present disclosure.

### EXAMPLE EMBODIMENT

Hereinafter, example embodiments according to the present disclosure will be described in detail with reference to the drawings. The example embodiments described below have technically preferable limitations for carrying out the present disclosure, but the scope of the invention is not limited to the following. All the drawings used in the following description of the example embodiments indicate similar parts with the same reference signs unless otherwise specified. The example embodiments below may not duplicate description of similar configurations and operations.

### First Example Embodiment

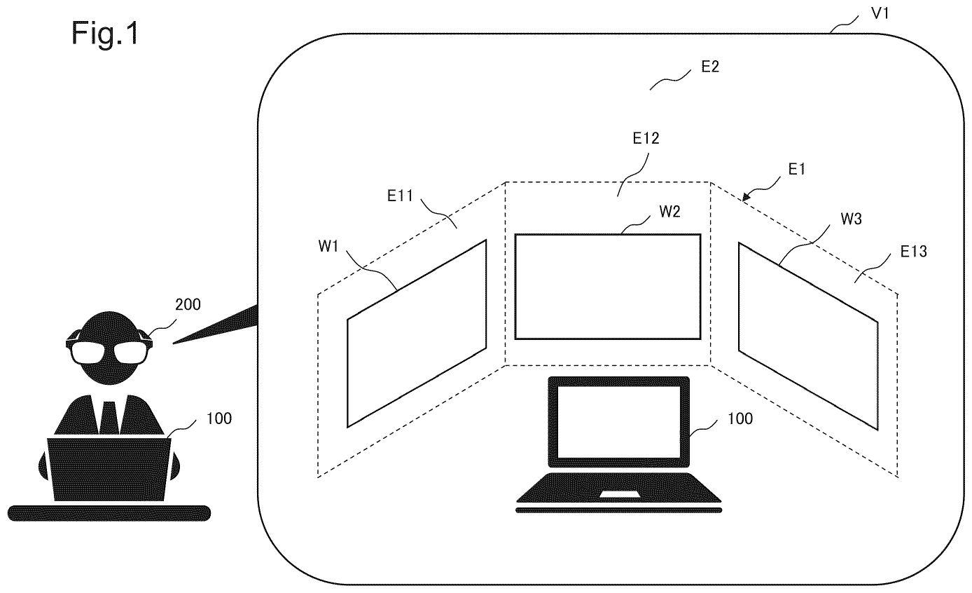

FIG. 1 is a conceptual diagram for illustrating a field of view V1 of a user who uses a display control system 1 according to a first example embodiment. The user of the display control system 1 wears smart glasses 200. The smart glasses 200 are an example of an information processing device capable of implementing mixed reality (MR). As is known, the smart glasses 200 superimpose and display video of a virtual space on a real space.

The video of the virtual space displayed on the smart glasses 200 is controlled by a display control device 100. The display control device 100 is implemented by an information processing device. FIG. 1 illustrates an example in which the display control device 100 is implemented by a personal computer (PC).

The field of view of the user through the smart glasses 200 is represented by V1. The field of view V1 includes a scene of the real space acquired by passing through lenses of the smart glasses 200 and a video of the virtual space displayed on the lenses of the smart glasses 200. The display control device 100 in the field of view V1 is in the scene of the real space. Virtual windows W1, W2, and W3 in the field of view VI are each a video of the virtual space. The virtual windows W1, W2, and W3 in the following description will be referred to as virtual windows W unless required to be distinguished. FIG. 1 illustrates three virtual windows W, for example. Any number of virtual windows W may be provided as long as multiple windows.

The virtual space of the smart glasses 200 includes a region of interest E1 and a region of non-interest E2. The region of interest E1 is set to dispose the virtual windows W related to work currently performed or immediately after performed by the user. The region of interest E1 may be further subdivided. For example, the region of interest E1 may be divided into regions E11, E12, and E13 as illustrated in FIG. 1. The region of non-interest E2 is set to dispose the virtual window W other than that disposed in the region of interest E1. The region of interest E1 and the region of non-interest E2 each may display information other than the virtual window W. Examples of the information other than the virtual window W include a user interface such as a clock or a remaining battery level, and a pop-up notification of a message.

The display control device 100 determines placement information indicating each virtual window W that is to be disposed in which region. The display control device 100 transmits the placement information to the smart glasses 200. The smart glasses 200 acquire the placement information transmitted from the display control device 100. The smart glasses 200 display the virtual windows W on the lenses of the smart glasses 200 based on the acquired placement information.

Although FIG. 1 indicates boundary lines between the respective regions with broken lines for illustration, these broken lines are not displayed on the lenses of the smart glasses 200. That is, the user does not visually recognize the boundary lines between the respective regions. To clarify the respective regions, the boundary lines may be displayed on the lenses of the smart glasses 200.

### Configuration of Display Control System

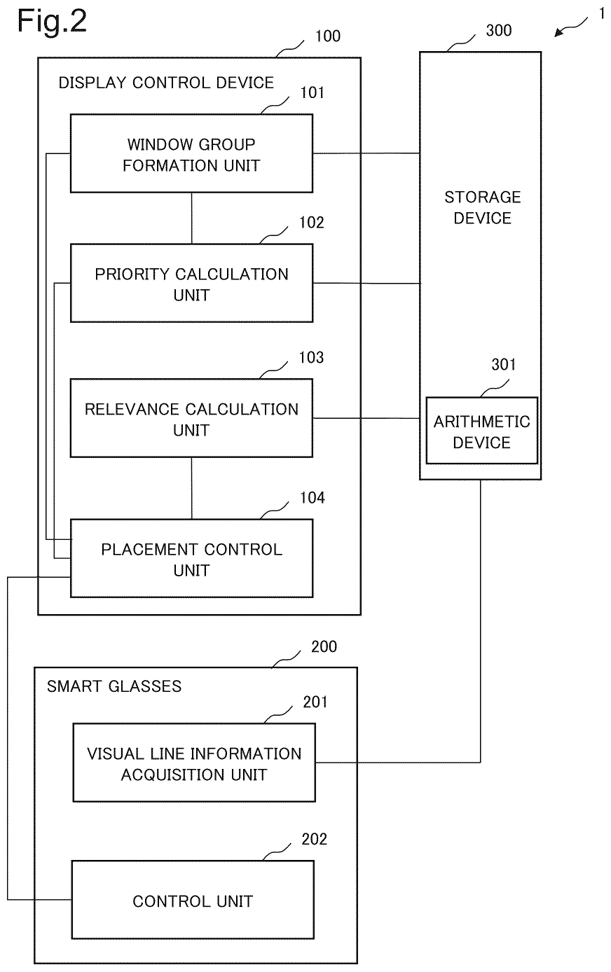

FIG. 2 is a block diagram illustrating a configuration of the display control system 1 according to the first example embodiment. As illustrated in FIG. 2, the display control system 1 includes the display control device 100, the smart glasses 200, and a storage device 300.

The display control device 100 is for controlling a video of the virtual space displayed on the smart glasses 200. Details of the display control device 100 will be described later.

The smart glasses 200 are communicably connected to the display control device 100 and the storage device 300. The smart glasses 200 include a visual line information acquisition unit 201 and a control unit 202. The visual line information acquisition unit 201 acquires visual line information on the user wearing the smart glasses 200. The visual line information includes at least one of gaze time information and visual line position information. The gaze time information relates to time when the user gazes at the virtual window W. Visual line trajectory information relates to a visual line position of the user on the virtual window W.

The visual line information acquisition unit 201 calculates visual line information by a known visual line measurement technique. The visual line information acquisition unit 201 is implemented by a visual line measurement device including an infrared light emitting element, a visual line detection sensor, and a detection unit, for example. The infrared light emitting element irradiates eyeballs of the user with infrared rays. The visual line detection sensor images reflected light of the eyeballs. The detection unit detects movement of a visual line and a gaze point on the display device based on positions of pupils. The detection unit also calculates the visual line information based on the movement of the visual line and the information on the gaze point on the display device. The visual line measurement technique described above is an example, and the visual line information can be calculated by various other methods conceivable by those skilled in the art.

The visual line information acquisition unit 201 acquires the visual line information at a predetermined frame rate. The predetermined frame rate is set in accordance with visual line moving speed of a general human. For example, the predetermined frame rate is set to 100 frames per second (fps) or less. For visual line tracking at high speed, the predetermined frame rate may be set to 100 fps or more. The visual line information acquisition unit 201 transmits the acquired visual line information to the storage device 300. The visual line information acquisition unit 201 associates identification information of the virtual window W gazed by the user with gaze time and transmits the associated identification information and the gaze time to the storage device 300.

The control unit 202 controls a video displayed on the lenses of the smart glasses 200. The control unit 202 controls display of the virtual window W based on the placement information transmitted from the display control device 100.

The storage device 300 stores information to be used for video control in the virtual space using the display control device 100. The storage device 300 stores at least one of a history of the visual line information, an operation history of the user, a received message history, schedule information, window tag information on the virtual window W, priority exclusion tag information, and placement region definition information. The history of the visual line information, the operation history of the user, and the received message history are also referred to as history information. The history of the visual line information is a history of the visual line information received from the smart glasses 200. The history of the visual line information includes the gaze time information and a history of the visual line position information. FIG. 2 illustrates an example in which the storage device 300 includes an arithmetic device 301. The arithmetic device 301 performs processing related to the information stored in the storage device 300.

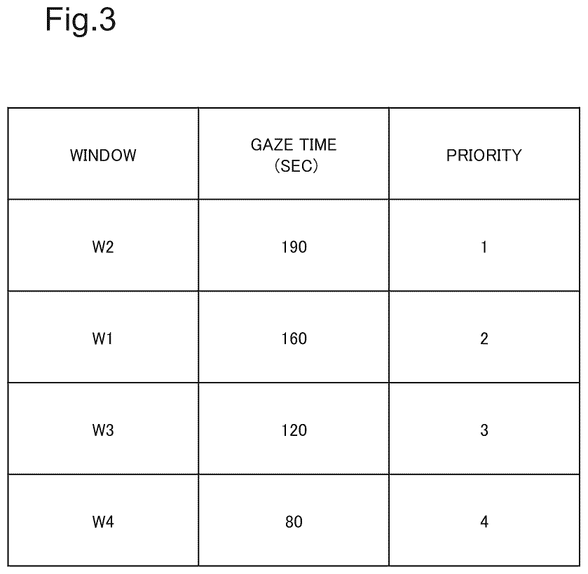

First, the gaze time information stored in the storage device 300 will be described with reference to FIG. 3. FIG. 3 is a diagram illustrating an example of the gaze time information.

As illustrated in FIG. 3, the storage device 300 associates identification information on the virtual window W gazed by the user, the gaze time, and a priority with each other and stores the associated information. The priority is calculated by a priority calculation unit 102 of the display control device 100. The gaze time and the priority included in the gaze time information are updated at preset timing. For example, the gaze time included in the gaze time information is updated at timing when the gaze time information is received from the smart glasses 200. The priority included in the gaze time information is updated at timing when the priority is received from the priority calculation unit 102. The gaze time may be reset at timing specified by the user. Alternatively, the gaze time may be reset at a predetermined time. For example, the gaze time may be designated to be reset at 0:00 AM and 0:00 PM.

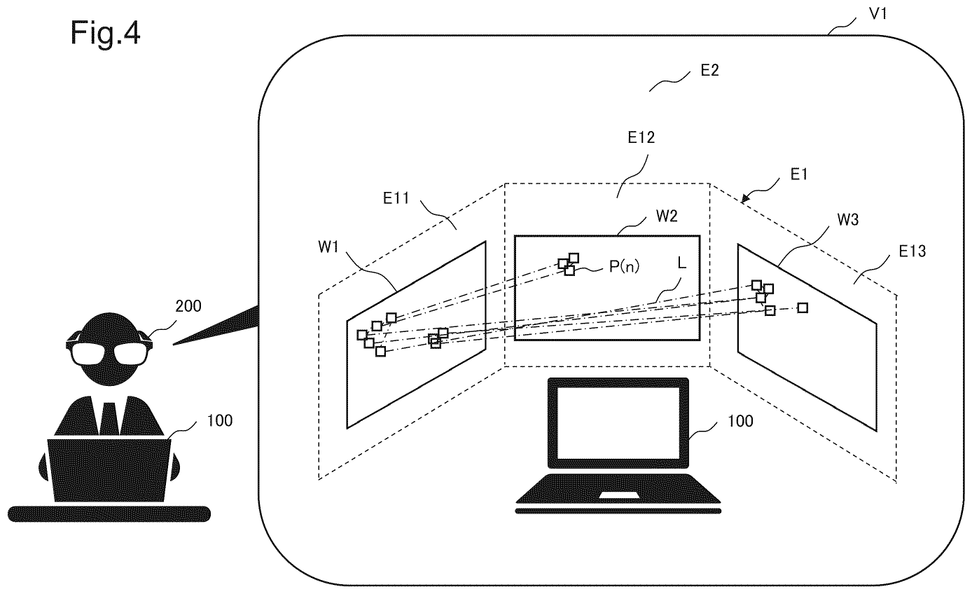

Next, the history of the visual line position information stored in the storage device 300 will be described with reference to FIG. 4. The history of the visual line position information stored in the storage device 300 is stored in the storage device 300 through processing performed by the arithmetic device 301, for example. FIG. 4 is an image diagram of the visual line trajectory information. FIG. 4 indicates a visual line trajectory L, which is a trajectory of a visual line, with a dot-and-dash line.

The arithmetic device 301 receives a visual line position P(n) of the user from the smart glasses 200 (n is a natural number). The visual line position P(n) includes information for identifying the virtual window W and a coordinate position in the virtual window W. The arithmetic device 301 plots coordinates of P(1), P(2), . . . , and P(n). The arithmetic device 301 may plot only the visual line position P(n) at which the gaze time is equal to or longer than a predetermined time. The arithmetic device 301 generates history information on the visual line position P(n), that is, the visual line trajectory L by connecting P(n) and P(n−1) with a straight line. The arithmetic device 301 stores the generated information in the storage device 300. Although the arithmetic device 301 has been described as a part of the configuration of the storage device 300, the present invention is not limited to this configuration. For example, the arithmetic device 301 may be implemented in an external terminal device, an external server, or a cloud.

The operation history of the user is information indicating a log of operation of the user on the user interface. Examples of the operation history of the user include information in which a time stamp indicating time when the operation has been performed is associated with an identification number of the virtual window W where the operation has been performed. The operation refers to an operation using a mouse or a keyboard. The operation history may include a time until the user takes an action on a schedule alarm notification.

The received message history is a history of received message information regarding reception of a message transmitted to the user. The received message information is collected from various applications. Examples of the received message information include a message from another user for communication. The received message may include a message such as an alert message based on a task or the like set in advance by the user. The storage device 300 stores the received message history in which a time stamp indicating a time at which a message is received is associated with text information included in the received message information.

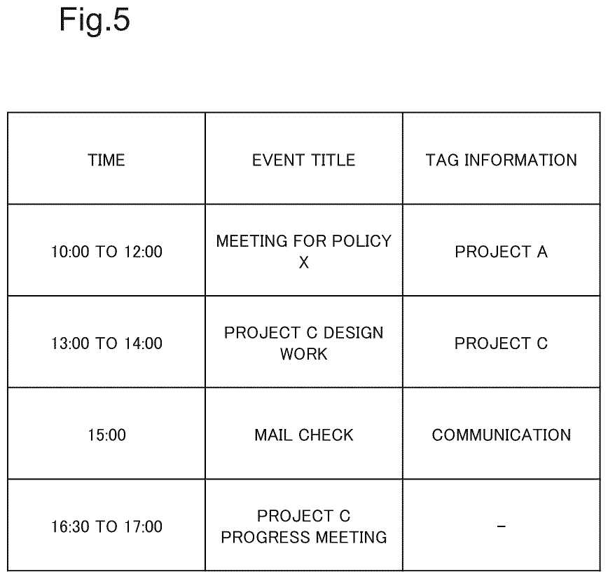

The schedule information is on the user. The schedule information is used as a priority of the virtual window W. FIG. 5 is an example of the schedule information stored in the storage device 300. The storage device 300 stores the schedule information in which a time at which an event is performed, an event title, and event tag information are associated with each other, for example. The event tag information is for identifying an event. Specific examples of the event tag information include a “project A”, a “project C”, and a “communication” as illustrated in FIG. 5. The event tag information may be registered in advance by the user or may be automatically added based on the event title.

Hereinafter, an example of a method for automatically adding the event tag information will be described. For example, the event title is assumed to be “project C progress meeting”. For the example, the storage device 300 divides the event title into tokens. The storage device 300 divides the event title into a “project C”, “progress”, and a “meeting”, for example. Next, the storage device 300 specifies corresponding event tag information by searching a list of the event tag information stored in advance with the divided tokens. Then, the storage device 300 adds the corresponding event tag information as the event tag information on the event. When there is no corresponding event tag information, the storage device 300 assigns the divided tokens as unset tag information. That is, one or more pieces of unset tag information are assigned to one event. When storing an event to which an unset tag is assigned, the storage device 300 searches for an event to which the same unset tag information is assigned. When finding the event to which the same unset tag is assigned, the storage device 300 adds the unset tag information as the event tag information on the event. At this time, the storage device 300 may automatically add the event tag information, or may add the event tag information after determination of the user. The assigned event tag information is newly registered in the list of the event tag information. The above-described method for adding the event tag information is an example, and thus the present invention is not limited to the above-described example.

The window tag information on the virtual window W is for identifying a type of the virtual window W. The window tag information is added for each virtual window W. The window tag information may be added in advance by the user or may be automatically added. Hereinafter, a method for automatically adding the window tag information will be described. There are two methods for automatically adding the window tag information on the virtual window W. The first method is automatic addition based on the operation history of the user and the schedule information on the user. The second method is automatic addition by natural language processing.

First, the automatic addition based on the operation history of the user and the schedule information on the user will be described. The storage device 300 adds window tag information to all the virtual windows W operated at a time when an event is performed, the window tag information being identical to event tag information on the event. For example, the virtual window W1 and the virtual window W3 are assumed to be operated at an event time “10:00 to 12:00”. The operated virtual windows W can be specified by referring to the operation history of the user. The storage device 300 in this example adds the “project A”, which is the event tag information on the event, to the virtual window W1 and the virtual window W3 as the window tag information. The storage device 300 may distinguish whether the virtual window W has been operated using a threshold determined in advance by the user. Examples of the predetermined threshold include a threshold for operation time of the virtual window W. When the operation time of the virtual window W is equal to or more than the threshold, the storage device 300 determines that the virtual window W has been operated. The predetermined threshold may be a movement distance of a mouse pointer displayed on the virtual window W, for example. When the moving distance of the mouse pointer is equal to or more than the threshold, the storage device 300 determines that the virtual window W has been operated.

Next, the automatic addition by the natural language processing will be described. First, the storage device 300 collects a site name and a file name displayed on the virtual window W. Next, the storage device 300 divides the collected site name or file name into tokens by a known natural language processing technique. Subsequently, the storage device 300 searches a list of window tag information stored in advance with the divided tokens, and specifies corresponding window tag information. Then, the storage device 300 adds the corresponding window tag information as tag information on the virtual window W. When there is no corresponding window tag information, the storage device 300 assigns the divided tokens as unset tag information. That is, at least one piece of unset tag information is allocated to the virtual window W. When storing the virtual window W to which an unset tag is assigned, the storage device 300 searches for the virtual window W to which the same unset tag information is assigned. When finding the virtual window W to which the same unset tag is assigned, the storage device 300 adds the unset tag information as the window tag information on the virtual window W. At this time, the storage device 300 may automatically add the window tag information, or may add the window tag information after determination of the user. The assigned window tag information is newly registered in the list of the window tag information.

The priority exclusion tag information is window tag information to which no priority is assigned. Some of the virtual windows W do not need to be disposed in the region of interest E1 even with a long gaze time. The priority exclusion tag information is for preventing such a virtual window from being disposed in the region of interest E1. The priority exclusion tag information is preset by the user and stored in the storage device 300.

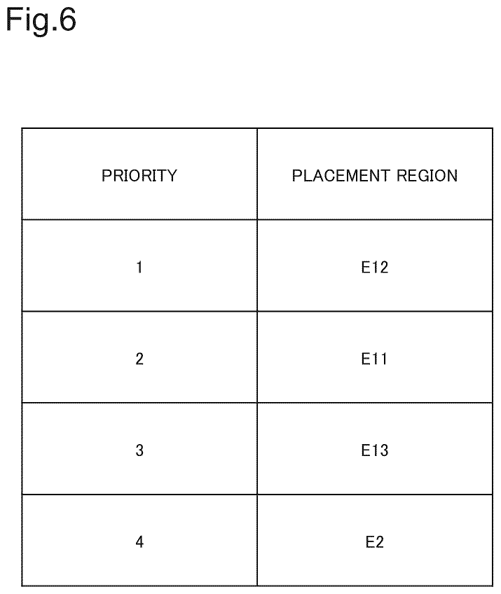

The placement region definition information includes the priority of the virtual window W and a placement region in which the virtual window W having the priority is to be disposed, which are associated with each other. FIG. 6 is a diagram illustrating an example of the placement region definition information. The placement region definition information as illustrated in FIG. 6 is defined in advance by the user or the like. Alternatively, the placement region definition information may be automatically generated with reference to the history of the visual line information stored in the storage device 300. Specifically, the placement region definition information may be automatically generated by assigning priority to each region in descending order of browsing frequency of the user.

### Configuration of Display Control Device

Next, a configuration of the display control device 100 will be described. As illustrated in FIG. 2, the display control device includes a window group formation unit 101, a priority calculation unit 102, a relevance calculation unit 103, and a placement control unit 104.

The window group formation unit 101 groups a plurality of relevant virtual windows W as a window group. Specifically, the window group formation unit 101 groups virtual windows to which the same window tag information is added as a window group using the window tag information added to the virtual window W.

The priority calculation unit 102 calculates a priority for each virtual window W. The priority is represented by a numerical value, for example. When the priority is represented by a numerical value, the priority is assumed to increase as the numerical value decreases, for example. For example, the priority calculation unit 102 calculates the priority according to update of the information in the storage device 300. The priority calculation unit 102 calculates the priority by using the gaze time information stored in the storage device 300. The priority calculation unit 102 may calculate the priority by using the gaze time within a recent predetermined time in the gaze time information. For example, the priority calculation unit 102 sorts the gaze time information in descending order of the gaze time as illustrated in FIG. 3. The priority calculation unit 102 may sort the gaze time information in ascending order of the gaze time. Then, the priority calculation unit 102 assigns the priority that increases as the gaze time increases. The priority calculation unit 102 assigns no priority to the virtual window W to which a priority exclusion tag is assigned. The priority calculation unit 102 associates the calculated priority with the identification information on the virtual window W and transmits the associated information to the storage device 300.

The priority calculation unit 102 may calculate not only the priority of the virtual window W but also a priority of each window group. The priority of the window group is referred to when the placement control unit 104 determines the window group to be disposed in a region of interest. The priority calculation unit 102 aggregates gaze times of respective virtual windows included in the window group. The priority calculation unit 102 sorts the aggregated gaze times in descending order or ascending order. Then, the priority calculation unit 102 assigns the priority that increases as the gaze time increases. The priority calculation unit 102 assigns no priority to the window group to which the priority exclusion tag is assigned. The priority calculation unit 102 associates the calculated priority with identification information on the window group and transmits the associated information to the storage device 300. When calculating the priority of the window group, the priority calculation unit 102 may also calculate the priority by using the gaze time within a recent predetermined time in the gaze time information.

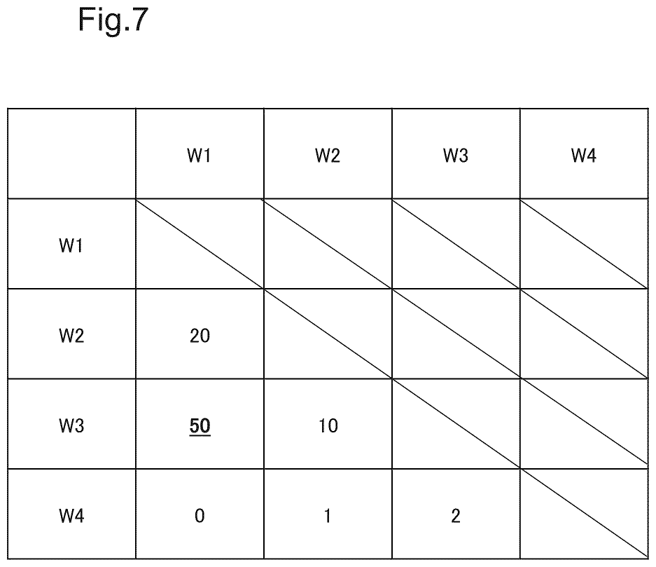

The relevance calculation unit 103 calculates a relevance ratio between mutual virtual windows. FIG. 7 is a diagram for illustrating a method for calculating the relevance ratio. An example of the method for calculating the relevance ratio between the mutual virtual windows will be described with reference to FIG. 7.

The relevance calculation unit 103 calculates a frequency of alternately referring to the virtual windows by using the visual line trajectory L. As illustrated in FIG. 4, the visual line trajectory L may extend over virtual windows. The relevance calculation unit 103 counts a frequency of extension of the visual line trajectory L over the virtual windows as a frequency of alternate reference to the mutual virtual windows. For example, the visual line trajectory L illustrated in FIG. 4 shows that a frequency of alternate reference to the virtual window W1 and the virtual window W2 is two, and a frequency of alternate reference to the virtual window W1 and the virtual window W3 is five.

As illustrated in FIG. 7, the relevance calculation unit 103 calculates a frequency of alternate reference to each virtual window. The relevance calculation unit 103 may calculate a frequency of alternate reference within a time designated in advance by the user. Then, the relevance calculation unit 103 determines that virtual windows have a high relevance ratio when the virtual windows have a frequency of alternate reference, the frequency being equal to or more than a predetermined threshold. The predetermined threshold is set in advance. For example, the predetermined threshold is assumed to be 40. The relevance calculation unit 103 determines that the virtual window W1 and the virtual window W3, which are illustrated in FIG. 7, have a high relevance ratio. The relevance calculation unit 103 associates the calculated relevance ratio with the identification information of the virtual window W, and transmits the associated information to the storage device 300.

The placement control unit 104 controls placement of the virtual window W based on the priority of the virtual window W. The priority of the virtual window W includes the priority of the virtual window W calculated by the priority calculation unit 102. Specifically, the placement control unit 104 determines a window group to be displayed in the region of interest E1 based on the priority of the virtual window W. Alternatively, the placement control unit 104 may determine a window group to be displayed in the region of interest E1 based on the priority of the virtual window group.

First, a procedure will be described in which the placement control unit 104 determines a window group to be displayed in the region of interest E1 based on the priority of the virtual window W calculated by the priority calculation unit 102. The placement control unit 104 specifies a virtual window Wa (a is a natural number) having the highest priority with reference to the storage device 300. Then, the placement control unit 104 determines to dispose the window group including the virtual window Wa in the region of interest E1.

Next, a procedure will be described in which the placement control unit 104 determines a window group to be displayed in the region of interest E1 based on the priority of the window group calculated by the priority calculation unit 102. The placement control unit 104 specifies a window group having the highest priority with reference to the storage device 300. Then, the placement control unit 104 determines to dispose the specified window group in the region of interest E1.

As described above, the schedule information is used as the priority of the virtual window W. Based on the schedule information, a procedure will be described in which the placement control unit 104 determines a window group to be displayed in the region of interest E1. The placement control unit 104 acquires schedule information with reference to the storage device 300. Then, the placement control unit 104 acquires a current time t. Next, the placement control unit 104 acquires event tag information on an event to be performed at the current time t with reference to the schedule information. Then, the placement control unit 104 determines to dispose a window group in the region of interest E1, the window group having window tag information corresponding to the event tag information on the event performed at the current time t.

The placement control unit 104 may determine a window group to be displayed in the region of interest E1 based on the priority and the schedule information on the virtual window W included in the history of the visual line information. For example, a plurality of events is assumed to be performed at the current time t. For the plurality of events, the placement control unit 104 refers to the storage device 300. The placement control unit 104 specifies a virtual window W having the highest priority among the virtual windows W having the same window tag information as the event tag information on each event described above. The placement control unit 104 determines to arrange a window group including the specified virtual window W in the region of interest E1.

The placement control unit 104 further determines placement of the virtual windows W included in the window group. Specifically, the placement control unit 104 determines the placement of the virtual windows W included in the window group based on at least one of the priority and the relevance ratio stored in the storage device 300.

First, a procedure will be described in which the placement control unit 104 determines placement of the virtual windows W included in the window group based on the priority. The placement control unit 104 refers to the placement region definition information stored in the storage device 300 and the priority included in the history of the visual line information. Then, the placement control unit 104 determines the placement of the virtual windows W included in the window group and generates the placement information.

Next, a procedure will be described in which the placement control unit 104 determines the placement of the virtual windows W included in the window group based on the relevance ratio. The placement control unit 104 refers to the relevance ratio included in the history of the visual line information stored in the storage device 300. The placement control unit 104 determines the placement of the virtual windows W to cause the virtual windows each having a high relevance ratio to be adjacent to each other, and generates the placement information.

Next, a procedure will be described in which the placement control unit 104 determines the placement of the virtual windows W included in the window group based on the priority and the relevance ratio. The placement control unit 104 first refers to the placement region definition information stored in the storage device 300 and the priority included in the history of the visual line information. Next, the placement control unit 104 determines the placement of the virtual windows W included in the window group. Subsequently, the placement control unit 104 refers to the relevance ratio stored in the storage device 300. Then, the placement control unit 104 changes the placement to cause the virtual windows each having a high relevance ratio to be adjacent to each other.

Processing will be described using a specific example in which the placement control unit 104 determines the placement of the virtual window W based on the priority and the relevance ratio. For example, the storage device 300 is assumed to store the priority as illustrated in FIG. 3, the placement region definition information as illustrated in FIG. 6, and the relevance ratio as illustrated in FIG. 7.

First, the placement control unit 104 determines the placement of each virtual window with reference to the priority in FIG. 3 and the placement region definition information in FIG. 6. Specifically, the placement control unit 104 determines to dispose the virtual window W1 in the region E11, the virtual window W2 in the region E12, and the virtual window W3 in the region E13.

Next, the placement control unit 104 refers to the relevance ratio in FIG. 7. FIG. 7 shows combinations of the virtual windows W in which the combination of the virtual window W1 and the virtual window W3 is equal to or greater than a predetermined threshold (set to 40 in FIG. 7). The placement control unit 104 changes the placement to cause the virtual window W1 and the virtual window W3 to be adjacent to each other. For example, the placement control unit 104 causes the virtual window W1 and the virtual window W3 to be disposed adjacent to each other by swapping the virtual window W2 disposed in the region E12 for the virtual window W3 in the region E13. Alternatively, the placement control unit 104 may create a new region E14 in a region adjacent to the region E11, and dispose the virtual window W3 in the region E14.

### Operation of Display Control System

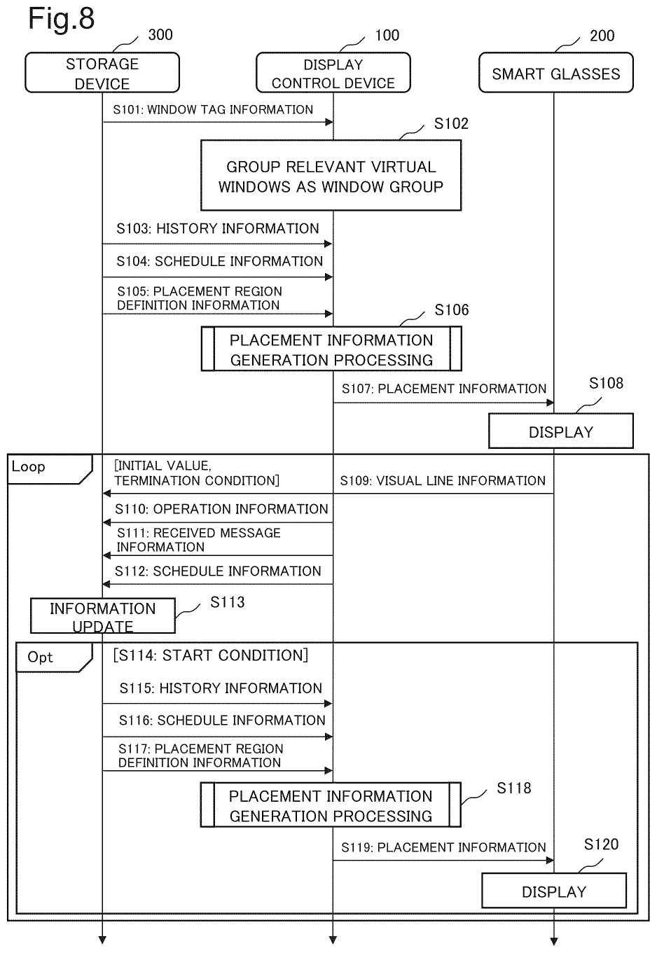

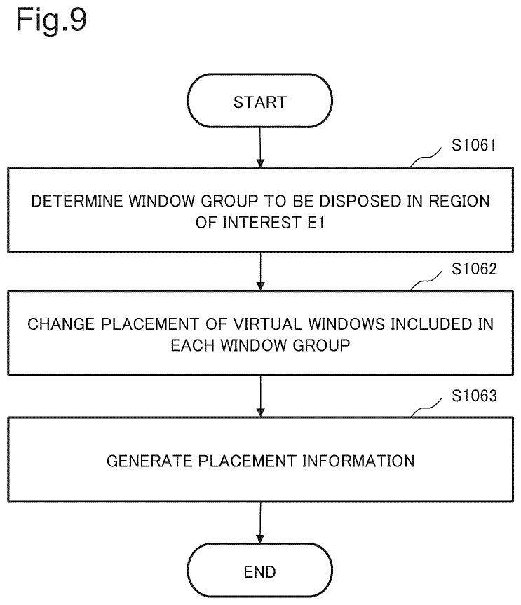

Next, an example of operation of the display control system 1 in the first example embodiment will be described with reference to FIGS. 8 and 9. FIG. 8 is a diagram illustrating an example of the operation of the display control system 1 according to the first example embodiment. FIG. 9 is a diagram illustrating an example of operation in placement information generation processing (steps S106 and S117 in FIG. 8) using the display control device 100. The display control system 1 according to the first example embodiment starts the processing when the smart glasses 200 is activated by the user, for example.

First, the display control device 100 acquires the window tag information of the virtual window W from the storage device 300 (step S101).

Next, the display control device 100 groups the relevant virtual windows W as a window group based on the acquired window tag information (step S102). Specifically, the window group formation unit 101 forms a window group by grouping the virtual windows W each having the same window tag information.

Next, the display control device 100 acquires history information from the storage device 300 (step S103). Specifically, the history information includes at least one of the history of the visual line information, the operation history of the user, and the received message history. The display control device 100 acquires the schedule information from the storage device 300 (step S104). The display control device 100 also acquires the placement region definition information from the storage device 300 (step S105). The order of the processing in step S103, step S104, and step S105 may be changed. The processing in step S103, step S104, and step S105 may be performed at the same timing.

Next, the display control device 100 performs the placement information generation processing using the information acquired in steps S103 to S105 (step S106). Operation of the placement information generation processing will be described with reference to FIG. 9.

First, the placement control unit 104 of the display control device 100 determines a window group to be disposed in the region of interest El using the priority of the virtual window W (step S1061). The placement control unit 104 determines a window group to be disposed in the region of interest E1 based on the priority of the virtual window W.

Processing for determining the window group to be disposed in the region of interest E1 based on the priority of the virtual window W included in the history of the visual line information is as follows.

First, the placement control unit 104 specifies the virtual window W having the highest priority by using the priority included in the history of the visual line information. Then, the placement control unit 104 determines to dispose the window group including the virtual window W having the highest priority in the region of interest E1.

Processing for determining a window group to be disposed in the region of interest E1 based on the schedule information is as follows. First, the placement control unit 104 acquires the current time t. Next, the placement control unit 104 acquires event tag information on an event to be performed at the current time t with reference to the schedule information. Then, the placement control unit 104 determines that a window group having window tag information corresponding to the event tag information of the event performed at the current time t has a high priority, and determines to dispose the window group in the region of interest E1.

Processing for determining the window group to be disposed in the region of interest E1 based on the priority of the virtual window W included in the history of the visual line information and the schedule information is as follows. First, the placement control unit 104 acquires the current time t. Next, the placement control unit 104 acquires event tag information on a plurality of events to be performed at the current time t with reference to the schedule information. Subsequently, the placement control unit 104 specifies a virtual window W having the highest priority among the virtual windows W having the same window tag information as the event tag information on each of the events. The placement control unit 104 determines to arrange a window group including the specified virtual window W in the region of interest E1.

Next, the placement control unit 104 determines the placement of the virtual windows W included in each window group (step S1062). Specifically, the placement control unit 104 changes the placement of the virtual windows W included in the window group based on at least one of the priority and the relevance ratio included in the history of the visual line information, and the placement region definition information. The placement control unit 104 may determine the placement of the virtual windows W for every window group, or may determine the placement only for the window group to be displayed in the region of interest E1.

Next, the placement control unit 104 generates placement information based on the placement of the window group determined in step S1062 (step S1063). When the series of processing described above is completed, the display control device 100 ends the placement information generation processing (proceeds to step S107 in FIG. 8).

The description returns to a flow of FIG. 8. Upon completion of the processing in step S106, the display control device 100 transmits the generated placement information to the smart glasses 200 (step S107).

The control unit 202 of the smart glasses 200 controls a video displayed on the lenses of the smart glasses 200 based on the placement information received from the display control device 100. Then, the control unit 202 displays the virtual window W on the lenses of the smart glasses 200 (step S108).

Next, the visual line information acquisition unit 201 of the smart glasses 200 acquires visual line information. The visual line information includes at least one of the gaze time information and the visual line position information as described above. The visual line information acquisition unit 201 transmits the acquired visual line information to the storage device 300 (step S109). The display control device 100 transmits operation information on the user to the storage device 300 (step S110). The display control device 100 transmits received message information received by the user from another person to the storage device 300 (step S111). The display control device 100 transmits the schedule information on the user to the storage device 300 (step S112). The order of the processing in step S109, step S110, step S111, and step S112 may be changed. The processing in step S109, step S110, step S111, and step S112 may be performed at the same timing. The display control device 100 may transmit not only the above information, but also a site name or a file name displayed on the virtual window W to the storage device 300.

The storage device 300 updates the information stored in the storage device 300 based on the information received in steps S109 to S112 (step S113). Specifically, the storage device 300 updates the history of the visual line information based on the information received in step S109 (step S113). The storage device 300 updates the operation history of the user based on the information received in step S110 (step S113). The storage device 300 updates the received message history based on the information received in step S111 (step S113). The storage device 300 updates the schedule information based on the information received in step S112 (step S113). The storage device 300 also updates the window tag information on the virtual window W based on the information received in step S112, or the site name or the file name displayed on the virtual window W (step S113).

Next, the display control device 100 determines whether a start condition for starting the processing related to the placement control (processing in steps S115 to S120) is satisfied (step S114). When the start condition is not satisfied, the processing returns to step S109. When the start condition is satisfied, the processing proceeds to step S115.

Specifically, the start condition is any one of three conditions described below. The first is a condition indicating whether the user has requested placement change. The second is a condition indicating whether a predetermined time has elapsed from the processing in step S108. The third is a condition indicating whether a time until the next event is within a predetermined time. The predetermined time is defined in advance by the user or the like.

When the user has requested the placement change, the display control device 100 determines that the start condition is satisfied. The user has requested the placement change as input through a user interface of the display control device 100 or the smart glasses 200, for example.

The display control device 100 determines that the start condition is satisfied when the predetermined time has elapsed from the processing in step S108. The predetermined time is defined in advance by the user or the like.

When the time until the next event is within the predetermined time, the display control device 100 determines that the start condition is satisfied. The predetermined time is defined in advance by the user or the like. The display control device 100 may determine that the start condition is satisfied when the current time is after a start time of the next event.

When it is determined that the start condition is satisfied, the display control device 100 starts the processing related to the arrangement control (processing of steps S115 to S120). First, the display control device 100 acquires the history information from the storage device 300 (step S115). Next, the display control device 100 acquires the schedule information from the storage device 300 (step S116). Subsequently, the display control device 100 acquires the placement region definition information from the storage device 300 (step S117). The order of the processing in step S115, step S116, and step S117 may be changed. The processing in step S115, step S116, and step S117 may be performed at the same timing.

The display control device 100 performs the placement information generation processing using the information acquired in steps S115 to S117 (step S118). The placement information generation processing is in steps S1061 to S1063 illustrated in FIG. 9. The processing in steps S1061 to S1063 is the same as the processing described in step S106, and thus will not be described in detail. For the start condition that is “whether the time until the next event is within a predetermined time”, the placement control unit 104 desirably controls the placement based on at least the schedule information. For another start condition, the placement control unit 104 controls the placement based on at least one of the history information and the schedule information.

Upon completion of the processing in step S118, the display control device 100 transmits the generated placement information to the smart glasses 200 (step S119).

The control unit 202 of the smart glasses 200 controls a video displayed on the lenses of the smart glasses 200 based on the placement information received from the display control device 100. Then, the control unit 202 displays the virtual window W on the lenses of the smart glasses 200 (step S120).

The display control system 1 repeats the series of processing from step S109 to step S120 until a predetermined termination condition is satisfied. Examples of the predetermined termination condition include a condition in which use of the smart glasses 200 is ended by the user. When the termination condition is satisfied, the display control system 1 ends the series of processing described above.

### Effect

The display control system according to the first example embodiment is configured as described above. Next, effect of the first example embodiment will be described.

The display control device according to the first example embodiment includes the window group formation unit and the placement control unit. The window group formation unit groups a plurality of relevant virtual windows as a window group. The placement control unit determines a window group to be disposed in a region of interest based on a priority of the virtual window. The display control device disposes a window group including a virtual window with a high priority in the region of interest. The display control device also disposes a window group with a higher relevance to an event, which is currently performed or immediately after performed by the user, in the region of interest. Thus, the present example embodiment enables improving work efficiency at work in an environment in which a plurality of virtual windows is simultaneously opened in a virtual space.

The placement control unit according to an aspect of the present example embodiment determines placement of a virtual window included in a window group based on at least one of a relevance ratio or a priority that is information indicating relevance of the virtual window. The display control device according to the present aspect disposes a virtual window having a high priority in a region to which the user is likely to pay attention. The display control device causes virtual windows with a higher relevance to be disposed adjacent to each other. Thus, the present aspect enables improving work efficiency at work in an environment in which a plurality of virtual windows is simultaneously opened in a virtual space in accordance with a relevance ratio or a priority.

The display control device according to an aspect of the present example embodiment includes the priority calculation unit that calculates a priority. The priority calculation unit determines the priority in accordance with a length of time during which the user gazes at the virtual window W. The priority calculation unit sets a higher priority to the virtual window W at which the user gazes for a longer time. That is, the priority calculation unit sets a higher priority to the virtual window W having a higher use frequency of the user. Thus, the present aspect enables improving work efficiency at work in an environment in which a plurality of virtual windows is simultaneously opened in a virtual space in accordance with a length of time during which the user gazes at a virtual window W.

The display control device according to an aspect of the present example embodiment includes the relevance calculation unit that calculates a relevance ratio. The relevance calculation unit determines the relevance ratio in accordance with a frequency of alternate reference to virtual windows performed by the user. Consequently, a distance by which a visual line of the user is moved between the virtual windows can be suppressed. Thus, the present aspect enables improving work efficiency at work in an environment in which a plurality of virtual windows is simultaneously opened in a virtual space in accordance with the frequency of alternate reference to the virtual windows performed by the user.

The window group formation unit according to an aspect of the present example embodiment groups mutual virtual windows having the same window tag information as a window group. The present aspect enables virtual windows with a higher relevance to be grouped as a window group based on the window tag information.

The placement control unit according to an aspect of the present embodiment determines to dispose a window group in a region of interest, the window group having window tag information corresponding to event tag information associated with an event included in schedule information. Consequently, the display control device according to the present aspect can dispose the window group with a higher relevance to the event, which is currently performed or immediately after being performed by the user, in the region of interest. Thus, the present aspect enables improving work efficiency at work in an environment in which a plurality of virtual windows is simultaneously opened in a virtual space in accordance with an event addressed by the user.

The placement control unit according to an aspect of the present example embodiment determines to dispose a window group including a virtual window having the highest priority in a region of interest. Consequently, the display control device according to the present aspect can dispose the virtual window with the highest priority of the user and a virtual window with a higher relevance to the virtual window in the region of interest. Thus, the present aspect enables improving work efficiency at work in an environment in which a plurality of virtual windows is simultaneously opened in a virtual space by disposing the virtual window having the highest priority in the region of interest.

The display control system according to an aspect of the present example embodiment includes the display control device and the smart glasses. The display control device transmits placement of the virtual window determined by the placement control unit to the smart glasses. The smart glasses control a video displayed on lenses (display units) of the smart glasses based on the placement of the virtual window received from the display control device. The present aspect enables displaying a video on the lenses (display units) of the smart glasses 200 in placement in which work efficiency can be improved at work in an environment in which a plurality of virtual windows is simultaneously opened in a virtual space.

In the present example embodiment, the placement of the virtual windows in the MR has been described. The method of the present example embodiment can also be applied to placement of virtual windows in virtual reality (VR), augmented reality (AR), and the like.

### Modified Example

The display control device 100 in the first example embodiment may be modified as follows.

Although the display control device 100 and the storage device 300 in the present example embodiment are illustrated as being implemented by different devices, the present invention is not limited to this configuration. For example, the display control device 100 may include a storage device having the function of the storage device 300.

The display control device 100 in the description of the operation of the present example embodiment has been described as acquiring the history information (step S103, step S114) and the schedule information (step S104, step $115) from the storage device 300. The display control device 100 does not necessarily acquire these pieces of information. The display control device 100 is only required to acquire information used in the placement information generation processing (step S106, step S117). For example, when the placement information is generated based on the schedule information, the placement control unit 104 may not acquire the history information.

### Second Example Embodiment

Next, a display control system 2 and a display control device 110 according to a second example embodiment will be described with reference to the drawings. The display control system 2 in the present example embodiment has a configuration acquired by simplifying the display control system 1 according to the first example embodiment.

### Configuration of Display Control System

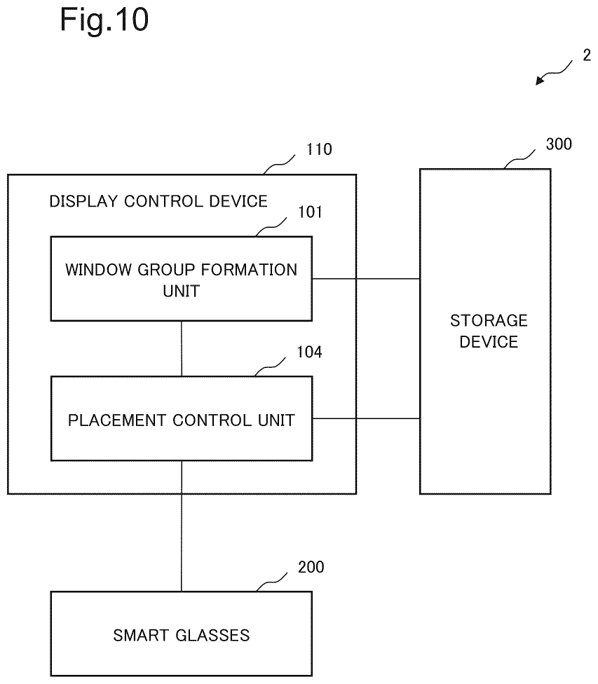

FIG. 10 is a diagram illustrating the configuration of the display control system 2 according to the second example embodiment. As illustrated in FIG. 10, the display control system 2 includes the display control device 110, smart glasses 200, and a storage device 300.

The smart glasses 200 are communicably connected to the display control device 110. The smart glasses 200 control display of the virtual window W based on placement information transmitted from the display control device 110.

The storage device 300 stores information to be used for video control in a virtual space using the display control device 110. The storage device 300 stores at least one of window tag information on the virtual window W, schedule information, and a priority of the virtual window W.

### Configuration of Display Control Device

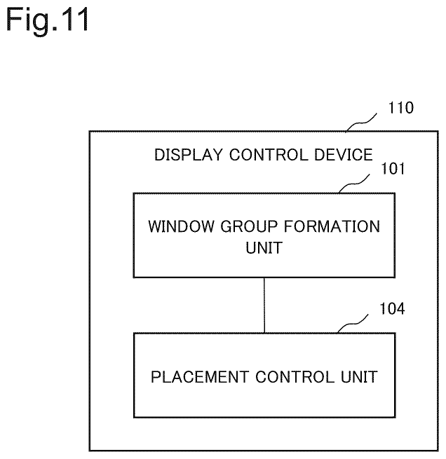

Next, a configuration of the display control device 110 will be described with reference to FIG. 11. As illustrated in FIG. 11, the display control device 110 includes a window group formation unit 101 and a placement control unit 104.

The window group formation unit 101 groups a plurality of relevant virtual windows W as a window group.

The placement control unit 104 determines a window group to be disposed in the region of interest E1 based on the priority of the virtual window W. Detailed processing of the placement control unit 104 is the same as that of the first example embodiment, and thus will not be described.

### Operation of Display Control Device

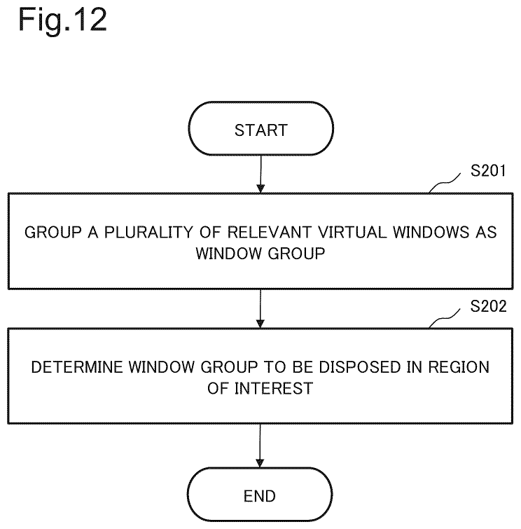

Next, operation of the display control device 110 in the second example embodiment will be described in detail with reference to FIG. 12.

FIG. 12 shows that the window group formation unit 101 first groups a plurality of relevant virtual windows W as a window group (step S201). For example, the window group formation unit 101 forms a window group by grouping virtual windows having the same window tag information.

Next, the placement control unit 104 determines a window group to be disposed in the region of interest E1 (step S202). For example, the placement control unit 104 determines a window group to be disposed in the region of interest E1 based on the priority of the virtual window W.

Upon completion of the series of processing described above, the placement control unit 104 transmits determined placement information to the smart glasses 200. The placement information transmitted to the smart glasses 200 is used to control the display of the virtual window W.

### Effect

The display control system 2 and the display control device of the second example embodiment are configured as described above. Next, effect of the display control device of the second example embodiment will be described.

The display control device according to the present example embodiment disposes a window group including a virtual window with a high priority in a region of interest to which the user pays attention. The display control device of the present example embodiment disposes a window group with a higher relevance to an event, which is currently performed or immediately after performed by the user, in the region of interest. Thus, the present example embodiment enables improving work efficiency at work in an environment in which a plurality of virtual windows is simultaneously opened in a virtual space.

### Hardware Configuration Using Computer

Each component in each example embodiment of the present disclosure described above can be implemented not only by hardware but also by a computer device or firmware based on program control.

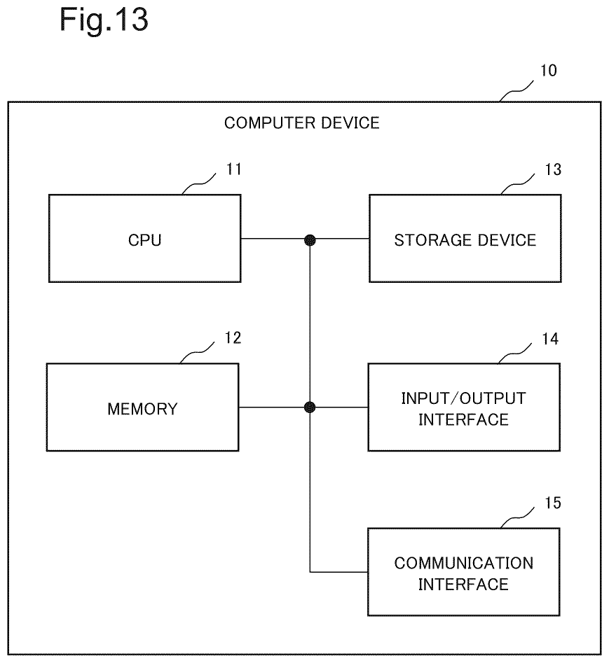

FIG. 13 is a diagram illustrating an example of a hardware configuration in which the display control device in the present disclosure is implemented by a computer device 10 including a processor. The display control device of each example embodiment is implemented by the computer device 10. As illustrated in FIG. 13, the computer device 10 includes a central processing unit (CPU) 11, a memory 12, a storage device 13 such as a hard disk that stores a program, an input/output interface 14 for connection to an input device and an output device, and a communication interface 15 for network connection.

The CPU 11 operates an operating system to control the display control device of the present disclosure. For example, the CPU 11 reads out a program or data from a storage medium attached to a drive device or the like to the memory 12. The CPU 11 also functions as a part of the window group formation unit 101, the priority calculation unit 102, the relevance calculation unit 103, or the placement control unit 104 in the display control device of the present disclosure, for example, and performs processing or a command based on a program.

Examples of the storage device 13 include an optical disc, a flexible disk, a magneto-optical disc, an external hard disk, and a semiconductor memory. The storage device includes storage media, some of which is a non-volatile storage device, and records a program in the non-volatile storage device. Then, the program may be downloaded from an external computer (not illustrated) connected to a communication network.

The input/output interface 14 is connected to an input device that is implemented by a mouse or a keyboard, for example, and that is used for input operation. Similarly, the input/output interface 14 is connected to an output device that is implemented by a display, for example, and that is used to display and check an output result.

Although the present disclosure has been described with reference to each of the example embodiments, the present disclosure is not limited to the example embodiments. Various modifications, which can be understood by those skilled in the art, can be made to the configuration and details of the present disclosure within the scope of the present disclosure. For example, although the plurality of operations is described in order in the form of a flowchart, the order of description does not limit the order of performing the plurality of operations. Thus, when each example embodiment is implemented, the order of the plurality of operations can be changed within a range without interference with contents.

Some or all of the above example embodiments can also be described as supplementary notes below.

### Supplementary Note 1

A display control device including:
window group formation means for grouping a plurality of relevant virtual windows as a window group; and
placement control means for determining a window group to be disposed in a region of interest based on a priority of each of the virtual windows.

### Supplementary Note 2

The display control device described in Supplementary note 1, wherein the placement control means determines placement of the virtual windows included in the window group based on at least one of a relevance ratio and the priority that are each information indicating relevance of the virtual windows.

### Supplementary Note 3

The display control device described in Supplementary note 1 or 2, further including:
priority calculation means for calculating the priority,
the priority calculation means determining the priority in accordance with a length of time during which a user gazes at each of the virtual windows.

### Supplementary Note 4

The display control device described in Supplementary note 2, further including:
relevance ratio calculation means for calculating the relevance ratio,
the relevance ratio calculation means determining the relevance ratio in accordance with a frequency of alternate reference to the virtual windows performed by the user.

### Supplementary Note 5

The display control device described in any one of Supplementary notes 1 to 4, wherein
the virtual windows are each associated with window tag information for identifying a type of corresponding one of the virtual windows, and
the window group formation means groups virtual windows identical in the window tag information as the window group.

### Supplementary Note 6

The display control device described in any one of Supplementary notes 1 to 5, wherein
the virtual windows are each associated with window tag information for identifying a type of corresponding one of the virtual windows,
the priority includes schedule information on the user,
the schedule information includes an event associated with event tag information, and
the placement control means determines to dispose the window group having the window tag information corresponding to the event tag information in the region of interest.

### Supplementary Note 7

The display control device described in any one of Supplementary notes 1 to 6, wherein the placement control means determines to dispose the window group including the virtual window having the highest priority in the region of interest.

### Supplementary Note 8

A display control system including:
the display control device described in any one of Supplementary notes 1 to 7; and
smart glasses including at least display means,
wherein the display control device transmits placement determined by the placement control means to the smart glasses, and
the smart glasses controls a video to be displayed on a display unit of the smart glasses based on the placement received from the display control device.

### Supplementary Note 9

A display control method including:
grouping a plurality of relevant virtual windows as a window group using a display control device; and
determining a window group to be disposed in a region of interest based on a priority of each of the virtual windows using the display control device.

### Supplementary Note 10

A computer-readable storage medium that stores a computer program for causing a computer to execute processing of:
grouping a plurality of relevant virtual windows into a window group; and
determining the window group to be disposed in a region of interest based on a priority of each of the virtual windows.

This application is based upon and claims the benefit of priority from Japanese patent application No. 2023-057037, filed on Mar. 31, 2023, the disclosure of which is incorporated herein in its entirety by reference.

### REFERENCE SIGNS LIST

1,2 display control system
10 computer device
12 memory
13 storage device
14 Input/output interface
15 communication interface
100, 110 display control device
101 window group formation unit
102 priority calculation unit
103 relevance calculation unit
104 placement control unit
200 smart glasses
201 visual line information acquisition unit
202 control unit
300 storage device
301 arithmetic device

What is claimed is:

1. A display control device comprising:
a memory storing instructions; and
a processor connected to the memory and configured to execute the instructions to:
group a plurality of relevant virtual windows as a window group; and
determine a window group to be disposed in a region of interest based on a priority of each of the virtual windows.

2. The display control device according to claim 1, wherein
the processor is configured to execute the instructions to determine placement of the virtual windows included in the window group based on at least one of a relevance ratio and the priority that are each information indicating relevance of the virtual windows.

3. The display control device according to claim 1, wherein
the processor is configured to execute the instructions to
calculate the priority, and
determine the priority in accordance with a length of time during which a user gazes at each of the virtual windows.

4. The display control device according to claim 2, wherein
the processor is configured to execute the instructions to
calculate the relevance ratio, and
determine the relevance ratio in accordance with a frequency of alternate reference to the virtual windows performed by the user.

5. The display control device according to claim 1, wherein
the virtual windows are each associated with window tag information for identifying a type of corresponding one of the virtual windows, and
the processor is configured to execute the instructions to group virtual windows identical in the window tag information as the window group.

6. The display control device according to claim 1, wherein
the virtual windows are each associated with window tag information for identifying a type of corresponding one of the virtual windows,
the priority includes schedule information on the user,
the schedule information includes an event associated with event tag information, and
the processor is configured to execute the instructions to determine to dispose the window group having the window tag information corresponding to the event tag information in the region of interest.

7. The display control device according to claim 1, wherein
the processor is configured to execute the instructions to determine to dispose the window group including the virtual window having the highest priority in the region of interest.

8. A display control system comprising:
the display control device according to claim 1; and
smart glasses including at least display means, wherein
the display control device is configured to transmit placement of a virtual window determined by the display control device to the smart glasses, and
the smart glasses are configured to control a video to be displayed on the display of the smart glasses based on the placement of the virtual window received from the display control device.

9. A display control method comprising:
grouping a plurality of relevant virtual windows as a window group using a display control device; and
determining a window group to be disposed in a region of interest based on a priority of each of the virtual windows using the display control device.

10. A computer-readable storage medium that stores a computer program for causing a computer to execute processing of:
grouping a plurality of relevant virtual windows into a window group; and
determining the window group to be disposed in a region of interest based on a priority of each of the virtual windows.
